(19) United States
(12) Patent Application Publication
(10) Pub. No.: US 2023/0033597 A1
(43) Pub. Date: Feb. 2, 2023

(54) MULTI-SUBJECT COOPERATION PLAN SYSTEM AND MULTI-SUBJECT COOPERATION PLAN METHOD

(71) Applicant: Hitachi, Ltd., Chiyoda-ku, Tokyo (JP)

(72) Inventors: Yumiko ISHIDO, Chiyoda-ku, Tokyo (JP); Yuichi KOBAYASHI, Chiyoda-ku, Tokyo (JP)

(21) Appl. No.: 17/789,156

(22) PCT Filed: Dec. 29, 2020
(86) PCT No.: PCT/JP2020/049290

§ 371 Date: Jun. 24, 2022

(30) Foreign Application Priority Data
Jan. 29, 2020 (JP) 2020-012131

(51) Int. Cl. G06Q 10/06

(52) U.S. Cl. CPC G06Q 10/0631

(57) ABSTRACT

Provided is a technology of facilitating coordination of an overall plan by making it possible to draft an operation plan that is easily acceptable to other planning subjects.

A system includes a draft plan creating device that creates a plurality of draft plans satisfying a given constraint condition, an evaluation device that evaluates each of the draft plans with a first algorithm and generates a self-evaluation value, an evaluation estimating device that evaluates each of the draft plans with a second algorithm different from the first algorithm and generates an estimated cooperation partner's evaluation value, and a cooperation partner's rate computing device that computes a rate indicating the weight of the estimated cooperation partner's evaluation value. In the system, the plurality of draft plans are evaluated on the basis of an objective function that is calculated from the self-evaluation value, the estimated cooperation partner's evaluation value, and the rate.

### TECHNICAL FIELD

The present invention relates to a multi-subject cooperation plan system and a multi-subject cooperation plan method.

### BACKGROUND ART

In the fields of transportation services and manufacturing industries where a plurality of resources are required to provide a service, operation plans of the respective resources are created to provide the service as planned. Operation plans of resources are created by respective management organizations, and a coordination work is necessary if a conflict occurs between the plans. Thus, efforts have been made to ensure consistency among the plans and create a plan that is feasible as a whole.

As examples of such a technology, the followings have been proposed. Specifically, there has been proposed a technology of, when scheduling a supply chain including allocation of suppliers of components or the like, manufacturing schedules of multiple factories, and allocation of delivery resources, creating a schedule starting with the allocation of suppliers by sharing information necessary for the scheduling and the scheduling results (see Patent Document 1).

Further, there has been proposed a “technology for allowing organizations that manage plans associated with each other to efficiently and swiftly execute a consistent coordination between the plans while appropriately maintaining confidentiality of information regarding the plans” (see Patent Document 2).

### PRIOR ART DOCUMENT

### Patent Documents

Patent Document 1: JP-2011-96141-A
Patent Document 2: WO2015/068231A1

### SUMMARY OF THE INVENTION

### Problems to be Solved by the Invention

In Patent Document 1, it is assumed that a plurality of factories accept assigned draft plans and go into production according to the plans. However, in the fields of transportation services and manufacturing industries, a plurality of companies or a plurality of departments in one company may serve as subjects for managing and planning resources that are required to provide a service. Therefore, suitable draft plans are different among the planning subjects, in some cases. Against such cases, any method for executing coordination of the plans and drafting a plan that is feasible as a whole has not been proposed.

Moreover, Patent Document 2 discloses a method for swiftly executing a consistent coordination between plans, but any method for drafting a plan that is feasible as a whole by coordinating inconsistencies if any has not been proposed.

Therefore, an object of the present invention is to provide a technology of facilitating coordination of an overall plan by making it possible to draft an operation plan that is easily acceptable to other planning subjects.

### Means for Solving the Problems

A preferable aspect of the present invention is a system including a draft plan creating device that creates a plurality of draft plans satisfying a given constraint condition, an evaluation device that evaluates each of the draft plans with a first algorithm and generates a self-evaluation value, an evaluation estimating device that evaluates each of the draft plans with a second algorithm different from the first algorithm and generates an estimated cooperation partner's evaluation value, and a cooperation partner's rate computing device that computes a rate indicating a weight of the estimated cooperation partner's evaluation value. In this system, the plurality of draft plans are evaluated on the basis of an objective function that is calculated from the self-evaluation value, the estimated cooperation partner's evaluation value, and the rate.

Another preferable aspect of the present invention is a multi-subject cooperation plan method that is executed by an information processing apparatus including a CPU and a storage device. This method includes a first step of reading a constraint condition from the storage device, a second step of creating, by the CPU, a plurality of draft plans satisfying the constraint condition, a third step of evaluating, by the CPU, each of the plurality of draft plans with a first algorithm and generating a self-evaluation value, a fourth step of evaluating, by the CPU, each of the plurality of draft plans with a second algorithm different from the first algorithm and generating an estimated cooperation partner's evaluation value, a fifth step of reading, from the storage device, cooperation partner's rate information that indicates a weight of the estimated cooperation partner's evaluation value, a sixth step of calculating, by the CPU, an objective function for each of the plurality of draft plans from the self-evaluation value, the estimated cooperation partner's evaluation value, and the cooperation partner's rate information, a seventh step of presenting, by the CPU, at least one draft plan selected from among the draft plans to a cooperation partner and receiving a reply to the selected draft plan, an eighth step of recording, by the CPU, contents of the reply as past reply information into the storage device, and a ninth step of updating, by the CPU, the cooperation partner's rate information on the basis of the past reply information.

### Advantages of the Invention

According to the present invention, a draft operation plan that is easily acceptable to other planning subjects can be made. Problems, configurations, and effects other than the abovementioned ones will be apparent from an embodiment that will be explained later.

### BRIEF DESCRIPTION OF THE DRAWINGS

FIG. 1 is a block diagram illustrating a system configuration according to an embodiment.

FIG. 2 is a hardware block diagram illustrating an internal configuration of a PC.

FIG. 3 is a table illustrating a data structure of past reply information 111 according to the embodiment.

FIG. 4 is a table illustrating a data structure of variable information in constraint condition information 112 according to the embodiment.

FIG. 5 is a table illustrating a data structure of constraint conditions expressed by variables in the constraint condition information 112 according to the embodiment.

FIG. 6 is a table illustrating a data structure of additional constraint information 113 according to the embodiment.

FIG. 7 is a table illustrating a data structure of draft plan information 114 according to the embodiment.

FIG. 8 is a table illustrating a data structure of estimated cooperation partner's evaluation index information 115 according to the embodiment.

FIG. 9 is a table illustrating a data structure of cooperation partner's rate information 116 according to the embodiment.

FIG. 10 illustrates a general system process flow according to the embodiment.

FIG. 11 is a schematic view of a result display screen according to the embodiment.

FIG. 12 is a schematic view of the result display screen on which a display form of cooperation partner's rate information has been changed in the embodiment.

FIG. 13 is a flowchart illustrating a procedure of creating an overall plan according to the embodiment.

### MODE FOR CARRYING OUT THE INVENTION

An embodiment will be described in detail with reference to the drawings. However, the present invention shall not be construed to be limited to the embodiment described below. A person skilled in the art can easily understand that the specific configuration of the embodiment can be modified without departing from the concept or gist of the present invention.

In the configuration of the present invention which will be described below, the same part or a part having a similar function is denoted by the same reference character throughout the drawings, and an overlapping explanation thereof may be omitted.

If there are two or more elements having the same or similar function, these elements may be described using the same reference character with different suffixes. However, if there is no need to distinguish these elements from each other, these elements may be described with the suffixes omitted.

The expressions such as “first,” “second,” and “third” used herein are intended to identify components, and do not necessarily limit the number, order, or details of the components. Further, a numeral for identifying a certain component is used for each context, and the numeral used in one context does not necessarily represent the same configuration in another context. Moreover, the above expressions do not hinder a component identified by a certain numeral from additionally having a function of a component identified by another numeral.

For easy understanding of the present invention, the position, size, shape, range, and the like of each of the configurations illustrated in the figures do not necessarily represent the actual position, size, shape, range, and the like. Therefore, the present invention is not necessarily limited to the position, size, shape, range, and the like disclosed in the drawings.

Publications, patents, and patent applications cited herein form a part of the explanation in the present specification, just as they are.

A component expressed in a singular form herein covers a plural form thereof unless the context otherwise specifies.

One example of a configuration that will be described in the embodiment is a multi-subject cooperation plan system. The multi-subject cooperation plan system includes a data reading device that reads a reply indicating an acceptance/rejection of a draft plan from a plan cooperation partner, a draft plan creating device that creates a plurality of draft plans satisfying a given constraint condition, an evaluation estimating device that estimates a cooperation partner's evaluation of a draft plan, a rate computing device that computes a rate indicating the priority level of a cooperation partner in a given time period, means for selecting, from among a plurality of draft plans, some draft plans for which a favorable object function is calculated from a self-evaluation value, a rate of a cooperation partner, and an estimated cooperation partner's evaluation value, and proposing the selected draft plans to a cooperation partner, and means for displaying the details of a draft plan accepted by all the cooperation partners. Further, the display means displays information including a self-evaluation, an estimated cooperation partner's evaluation value, and a cooperation partner's rate.

### First Embodiment

Hereinafter, an embodiment for carrying out the invention will be explained with reference to the drawings. First, a system configuration will be described.

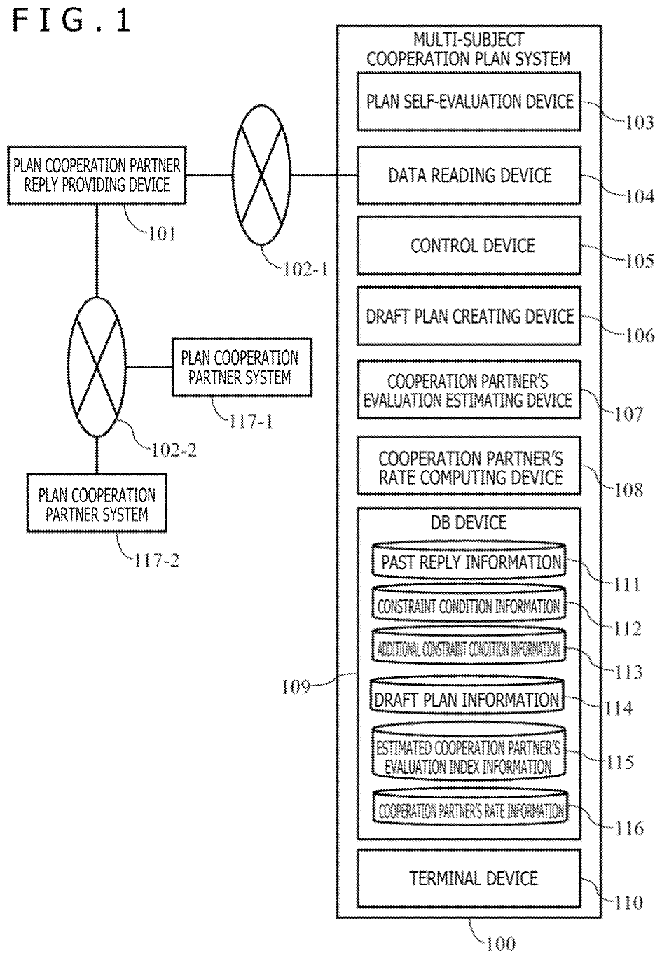

FIG. 1 is a system configuration diagram illustrating a system configuration according to the embodiment. In FIG. 1, a reference character 100 denotes a multi-subject cooperation plan system, a reference character 101 denotes a plan cooperation partner reply providing device, a reference character 102 denotes a network, a reference character 103 denotes a plan self-evaluation device, a reference character 104 denotes a data reading device, a reference character 105 denotes a control device, a reference character 106 denotes a draft plan creating device, a reference character 107 denotes a cooperation partner's evaluation estimating device, a reference character 108 denotes a cooperation partner's rate computing device, a reference character 109 denotes a DB device, a reference character 110 denotes a terminal device, a reference character 111 denotes past reply information, a reference character 112 denotes constraint condition information, a reference character 113 denotes additional constraint condition information, a reference character 114 denotes draft plan information, a reference character 115 denotes estimated cooperation partner's evaluation index information, a reference character 116 denotes cooperation partner's rate information, and a reference character 117 denotes a plan cooperation partner system.

The multi-subject cooperation plan system 100, the plan cooperation partner system 117, and the plan cooperation partner reply providing device 101 can communicate with each other over the network 102. In FIG. 1, two networks 102 are connected to each other via the plan cooperation partner reply providing device 101. This is one example, and there is no limit on the configuration of the network. In addition, in the present embodiment, the plan cooperation partner reply providing device 101 relays communication between the multi-subject cooperation plan system 100 and the plan cooperation partner system 117. However, the plan cooperation partner reply providing device 101 may be omitted such that direct communication between the multi-subject cooperation plan system 100 and the plan cooperation partner system 117 is performed.

The multi-subject cooperation plan system 100 and plan cooperation partner systems 117-1 and 117-2 are configured to manage respective resources that are provided for business or services, for example. In one example, it is assumed that the multi-subject cooperation plan system 100 manages a resource group A, the plan cooperation partner system 117-1 manages a resource group B, and the plan cooperation partner system 117-2 manages a resource group C. The multi-subject cooperation plan system 100 and the plan cooperation partner systems 117-1 and 117-2 may be operated by different business subjects (e.g. legal entities), or may be operated by different departments in one business subject.

In the present embodiment, it is assumed that the multi-subject cooperation plan system 100 makes a plan for a service using the resource group A. In the present embodiment, three subjects A to C are provided. However, the present embodiment is similarly applicable to a case where there are four or more subjects.

The plan cooperation partner reply providing device 101 provides plan information which is related to plans made by organizations managing one or more different resource groups (the resource group B, the resource group C, etc.,) and which is required to provide a service in cooperation with the resource group A for creating an operation plan using the multi-subject cooperation plan system 100. It is assumed that the plan information is transmitted from the plan cooperation partner systems 117-1 and 117-2 to the plan cooperation partner reply providing device 101. Further, the plan cooperation partner reply providing device 101 receives plan information regarding the resource group A, receives, from the plan cooperation partner systems 117-1 and 117-2, a reply indicating an acceptance of the resource group A or a correction request therefor made by the management organization of another resource group, and provides the received reply to the multi-subject cooperation plan system 100.

It is to be noted that the plan cooperation partner systems 117-1 and 117-2 may have a configuration similar to that of the multi-subject cooperation plan system 100. However, in the present embodiment, it is sufficient that the plan cooperation partner systems 117-1 and 117-2 have at least a function of receiving input of the above plan information or input of a reply indicating an acceptance or a correction request, and transmitting the received input to the plan cooperation partner reply providing device 101, and a function of receiving transmission from the plan cooperation partner reply providing device 101. It is assumed that the plan information, acceptances, and correction requests are inputted by persons in charge of the management organizations of the respective resource groups.

For example, in a railroad traffic service, it is assumed that the resource group A includes resources related to vehicle operation, the resource group B includes human resources related to operations of drivers or the like, and the resource group C includes resources (e.g. machines, facilities, and human resources such as maintenance workers) necessary for maintenance. In this case, the plan cooperation partner reply providing device 101 transmits, to the multi-subject cooperation plan system 100, an acceptance reply or a correction request made by an operator manpower management department and a maintenance department in response to a plan which is related to the resource group A and which is created by a vehicle operation plan management department. Moreover, in a case where a plan concerning the resource group A is accepted by the operator manpower management department and the maintenance department, an operator manpower plan and a maintenance plan created by the respective departments are provided to the multi-subject cooperation plan system 100. The correction request includes information in a form of providing a constraint condition to be satisfied by a corrected plan. The provision is usually conducted over the internet according to an HTTP (Hyper Text Transfer Protocol).

The network 102 is a medium, such as the internet or a dedicated network, which connects the plan cooperation partner reply providing device 101 and the multi-subject cooperation plan system 100. The network 102 establishes a connection in a wired or wireless manner, and may include multiple networks.

In order to provide a service in cooperation with resource groups (the resource groups B and C in the present embodiment) under management of one or more other organizations, the multi-subject cooperation plan system 100 creates an allocation plan of a resource group (the resource group A in the present embodiment) under management of the multi-subject cooperation plan system 100 itself. The multi-subject cooperation plan system 100 includes the plan self-evaluation device 103, the data reading device 104, the control device 105, the draft plan creating device 106, the cooperation partner's evaluation estimating device 107, the cooperation partner's rate computing device 108, the DB device 109, and the terminal device 110.

The plan self-evaluation device 103 computes an evaluation value of a draft plan created by the draft plan creating device 106, from the standpoint of a department where the plan has been created (a vehicle operation plan management department in the present embodiment). For example, when an operation plan of resources related to vehicle operation is evaluated, a transportation quantity of a vehicle is used as an evaluation criterion.

The data reading device 104 receives, as input, data provided by the plan cooperation partner reply providing device 101, and saves a constraint condition as the additional constraint condition information 113 if the past reply information 111 is saved in the DB device 109 and there is a correction request in the form of a constraint condition.

The control device 105 integrates the devices constituting the multi-subject cooperation plan system 100, and performs control to draft a multi-subject cooperation plan of the system. The control device 105 is configured to also perform control on a publicly-known process that is executed in a common PC. The publicly-known process is data exchange over the network 102, for example.

The draft plan creating device 106 reads constraint conditions saved in the constraint condition information 112 and the additional constraint condition information 113, and creates one or more draft operation plans of the resource group A satisfying the constraint conditions.

The cooperation partner's evaluation estimating device 107 computes an estimated evaluation value of a draft plan created by the draft plan creating device 106, from the standpoint of each of the cooperation partners (organization managing the resource group B and organization managing the resource group C, which are the operator manpower management department and the maintenance department in the present embodiment). In order to make an evaluation from a standpoint that is different from that held by the plan self-evaluation device 103, the cooperation partner's evaluation estimating device 107 uses an evaluation algorithm that is different from that in the plan self-evaluation device 103. For example, when an operation plan of resources that are necessary for maintenance is evaluated, the operation rate of devices is used as an evaluation criterion.

The cooperation partner's rate computing device 108 computes a rate that indicates the degree of importance of each organization managing the resource group B, the resource group C, or the like, to the organization managing the resource group A by using the multi-subject cooperation plan system 100.

The DB device 109 is a database (DB) in which data created by the devices is held. The DB device 109 includes the data including past reply information 111, the constraint condition information 112, the additional constraint condition information 113, the draft plan information 114, the estimated cooperation partner's evaluation index information 115, and the cooperation partner's rate information 116. It is to be noted that the DB has a function of registering data, searching for data, extracting related data, and deleting data. It is assumed that the DB device 109 of the present embodiment is implemented by a general PC. In this case, the DB device is realized by a general PC and general DB software that operates on the computer.

The terminal device 110 is a terminal that is operated by an operator of the multi-subject cooperation plan system 100. The terminal device 110 displays a draft operation plan of the resource group A, receives an acceptance from an operator, and proceeds a process flow. Data that is used by the terminal device 110 includes data which will be explained below.

The past reply information 111 is reply information that indicates an acceptance, a selection, or a rejection with an additional constraint condition in response to the operation plan of the resource group A proposed by the multi-subject cooperation plan system 100. The reply information is provided by the management organizations of the resource group B and the resource group C.

The constraint condition information 112 is a constraint condition that has been recognized by the resource group A when an operation plan of the resource group A is drafted. For example, in a case where the resource group A is related to vehicle operation, the constraint condition information 112 includes a condition where a vehicle can physically continue traveling. Examples of such a condition include the presence/absence of a vehicle, the presence/absence of a rail, and whether a travel time period is sufficient. In addition, for example, in a case where the resource group A is related to maintenance, the constraint condition information 112 includes the presence/absence of a maintenance facility, the presence/absence of a maintenance worker, and whether a maintenance time period is sufficient.

The additional constraint condition information 113 is a constraint condition that is added by the organization managing the resource group B or the resource group C, that is, a management organization that provides a service in cooperation with the organization managing the resource group A, when the organization managing the resource group B or the resource group C drafts an operation plan of the resource group A. For example, in a case where the resource group A is related to vehicle operation and the resource group C is related to maintenance, the organization managing the resource group C places an additional constraint condition for “moving a specific vehicle to a specific place by a specific time in order to maintain the vehicle.”

The estimated cooperation partner's evaluation index information 115 is information regarding an estimated value of an evaluation of the draft operation plan of the resource group A from the standpoint of each of the organizations managing the resource group B and the resource group C. The estimated cooperation partner's evaluation index information 115 may indicate a set of estimated evaluation values for each draft plan, or a function for calculating an estimated evaluation value from the draft operation plan.

The cooperation partner's rate information 116 indicates the degree of importance of the organization managing the resource group B or the resource group C, to the organization managing the resource group A. It is to be noted that the details of the data will be explained later.

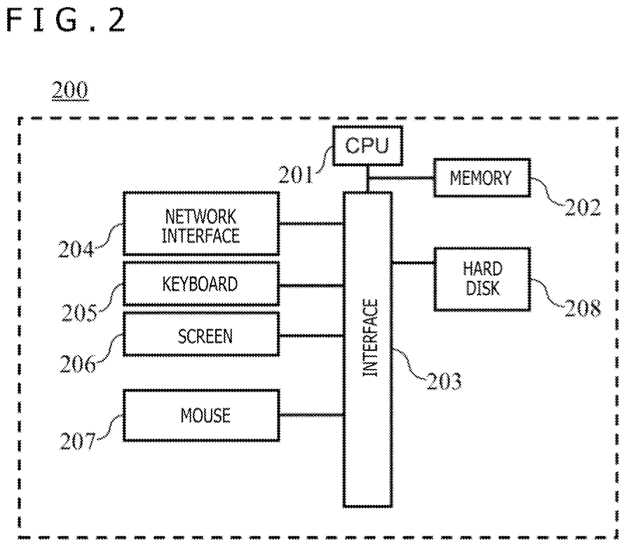

In the present embodiment, it is assumed that the system 117 and the devices 101 and 103 to 110 in FIG. 1 are implemented by general PCs. However, each of the systems and devices may be implemented by not a general PC but a dedicated machine. In addition, it is assumed that the devices in FIG. 1 are connected to one another over a network. Alternatively, the devices and systems in FIG. 1 may be formed by a single personal computer, or the functions of the devices and systems may be divided into any number of personal computers. Hereinafter, as the configuration of each device, which is an internal configuration of a general personal computer, the configuration of a PC 200 in FIG. 2 will be explained.

In FIG. 2, a reference character 201 denotes a CPU, a reference character 202 denotes a memory, a reference character 203 denotes an interface, a reference character 204 denotes a network interface, a reference character 205 denotes a keyboard, a reference character 206 denotes a screen, a reference character 207 denotes a mouse, and a reference character 208 denotes a hard disk.

The CPU 201 is a central processing unit, and is capable of executing a program that is recorded in the memory 202 or that has been transferred from the hard disk 208 to the memory 202. It is to be noted that the program can be used by a PC, if needed, and may be introduced from a detachable storage medium. In this case, a device for reading data from the storage medium is connected to the interface 203. It is to be noted that a device that uses an optical disk (e.g. a CD, a DVD, or a blue-ray disk) or a device that uses a flash memory is commonly known and can be used as the storage medium and a reading device therefor. In addition, the program may be installed into the PC through the network interface 204 via a communication medium (a communication line or a carrier wave on a communication line), if needed.

In the memory 202, a program and data are temporarily recorded. The interface 203 connects devices in the PC system to one another. The network interface 204 communicates with, for example, a PC external to the PC system. The keyboard 205 is manipulated by an operator of the PC system in order to input a command and data to the PC system. The screen 206 displays a process result, etc. The mouse 207 designates a position on the screen by the operator moving a pointer displayed on the monitor and depressing a button at any position, whereby a certain action is sent to the CPU 201. It is to be noted that the mouse 207 may be replaced with any other pointing device such as a touch panel. When the mouse 207 is replaced with a touch panel, no pointer is usually required. The hard disk 208 stores a program and data. The hard disk 208 can include a magnetic disk or a nonvolatile memory, for example. In this case, a program and data stored in the hard disk 208 are held even after the hard disk 208 is turned off and is then turned on. It is to be noted that an operating system (OS) may previously be installed in the hard disk 208. With this, a program can be designated by a file name. The OS refers to basic computer software. An OS that has been widely known can be used therefor.

The hardware configuration of the present system has been explained with reference to the PC 200 illustrated in FIG. 2. When a program stored in the hard disk 208 or the memory 202 is executed by the CPU 201 to perform predetermined computation and processing in collaboration with separate hardware, the functions of the system 117 and the devices 101 and 103 to 110 in FIG. 1 are implemented. The devices may include respective personal computers, or all the devices may include a single personal computer, as previously described. Alternatively, each of the devices may include a plurality of personal computers that are connected to one another over a network. Functions equivalent to those implemented by the program in the embodiment can be implemented by hardware such as an FPGA (Field Programmable Gate Array) or an ASIC (Application Specific Integrated Circuit). Next, a data structure will be explained.

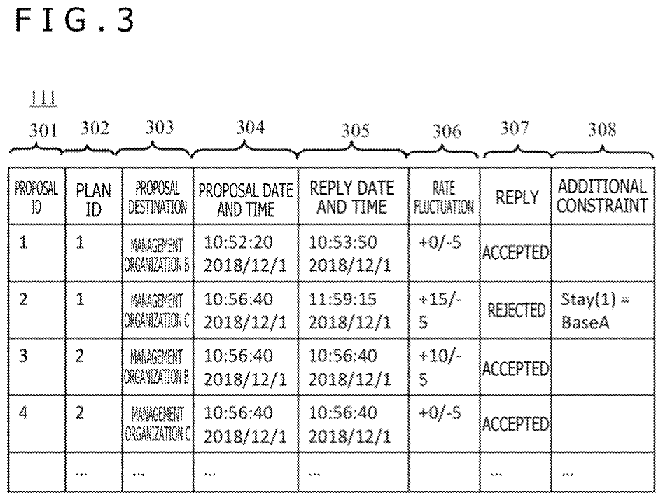

First, the past reply information 111 according to the embodiment will be explained with reference to FIG. 3. The past reply information 111 is created by the control device 105. FIG. 3 illustrates a data structure of the past reply information 111 according to the embodiment.

A proposal ID 301 is a number for uniquely identifying a process of proposing a plan to another organization. When a draft operation plan created by the draft plan creating device 106 is transmitted to a specific plan cooperation partner system 117, a proposal ID thereof is created. A plan ID 302 is a number for uniquely identifying a draft operation plan of the resource group A to be proposed. When a draft operation plan is created by the draft plan creating device 106, a plan ID thereof is created. For example, in a case where the same draft plan is proposed to a plurality of different organizations, the draft plan is recorded with one plan ID and different proposal IDs.

The proposal destination 303 indicates the name of a proposal destination organization in the proposing process. A proposal date and time 304 indicates a date and time when the organization managing the resource group A transmits a draft plan to a proposal destination in the proposing process, and a reply date and time 305 indicates a date and time when a reply made by the proposal destination organization to the draft plan is received from the plan cooperation partner reply providing device 101 in the proposing process.

A rate fluctuation 306 indicates a rate fluctuation value when a proposal destination has accepted/rejected the draft plan. In FIG. 3, a numerical value before the sign “/” is a rate fluctuation value when the proposal destination accepts the draft plan, and a numerical value after “/” is a rate fluctuation value when the proposal destination rejects the draft plan.

In the present embodiment, it is assumed that the rate fluctuation 306 fluctuates with time. The value of the fluctuation is calculated by the cooperation partner's evaluation estimating device 107, which will be explained later.

A reply 307 is made by the proposal destination in response to the proposal. An additional constraint 308 indicates an additional constraint which is requested when a reply from the proposal destination is a rejection. A reply and an additional constraint from the proposal destination are inputted by an operator of the proposal destination through, for example, a keyboard of the plan cooperation partner system 117. Next, a data structure of the constraint condition information 112 and a data structure of the additional constraint condition information 113 according to the embodiment will be explained.

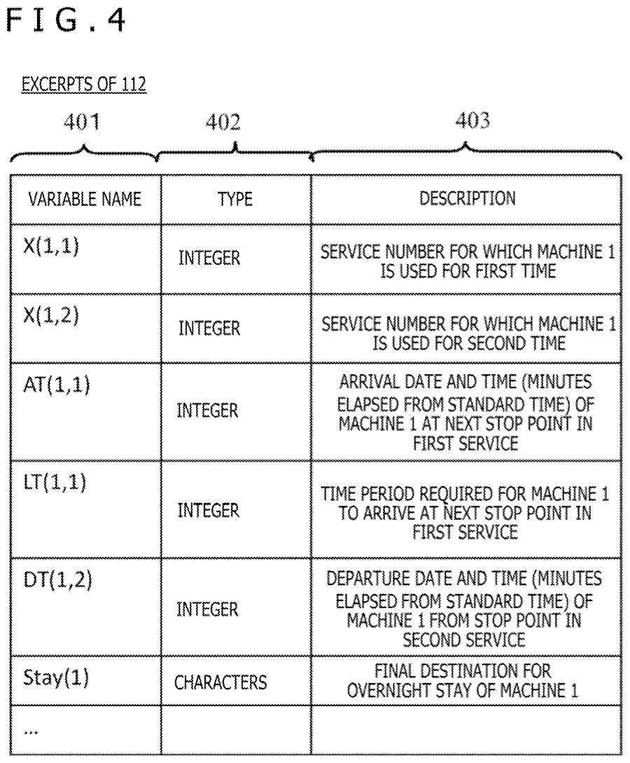

FIG. 4 illustrates a data structure of constraint variables in the constraint condition information 112 according to the embodiment. A variable name 401 indicates a decision variable which is a variable to be decided to describe an operation plan. A type 402 indicates the type of each variable. Examples of a possible type of each variable include an integer, a real number, a character variable, and a Boolean type variable. A description 403 indicates the meaning of the variable. For example, a “variable”: X(1,1) can take an integer value, and indicates a service number for which a machine 1 is used for the first time. It is assumed that an operator (e.g. a person managing the resource group A) defines a data structure of the constraint variable, and inputs the data structure through the terminal device 110 such that the data structure is saved in the DB device 109 before the system is operated.

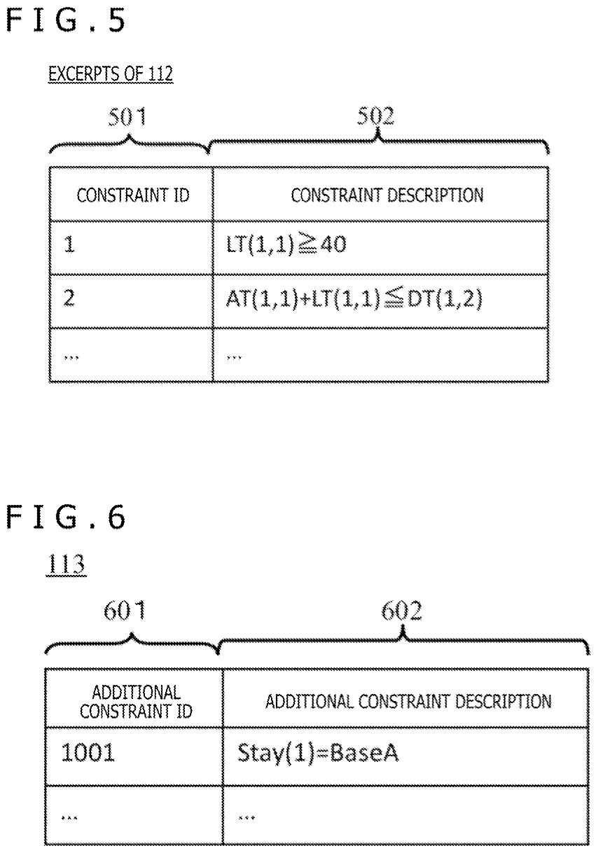

FIG. 5 illustrates a data structure of a constraint condition that is included in the constraint condition information 112 according to the embodiment and that is to be satisfied by the decision variable. A constraint ID 501 uniquely identifies a constraint. A constraint description 502 indicates the description of the constraint. For example, “LT(1,1)≥40” is the constraint description of the “constraint ID” defined as “1.” That is, this describes that a time period that is required for the machine 1 to arrive at the next stop point in the first service is 40 minutes or longer. An operator (e.g. a person managing the resource group A) defines the description of each constraint condition, and inputs the description through the terminal device 110 such that the description is saved in the DB device 109 before the system is operated.

By using the data in FIGS. 4 and 5 and the functions of the DB device, the draft plan creating device 106 can consult a constraint condition to be satisfied when a draft operation plan of the resource A is made.

FIG. 6 illustrates a data structure of an additional constraint condition that is included in the additional constraint condition information 113 according to the embodiment and that is to be satisfied by the decision variable.

An additional constraint ID 601 uniquely identifies an additional constraint. An additional constraint description 602 indicates the description of the additional constraint. For example, “Stay(1)=BaseA” is an “additional constraint description” of an additional constraint the “additional constraint ID” of which is “1001.” That is, the final destination for overnight stay of the machine 1 is BaseA. The additional constraint description 602 is inputted to the plan cooperation partner system 117 by an operator of a proposal destination to which a draft operation plan has been proposed, if the operator does not simply accept the draft operation plan. As illustrated in FIG. 6, the variable name 401 in the data regarding the constraint variables illustrated in FIG. 4 is quoted in the additional constraint description 602. The additional constraint description 602 is transmitted from the plan cooperation partner reply providing device 101, and is recorded into the DB device 109 through the data reading device 104.

With the abovementioned data in FIGS. 4 and 6 and the function of the DB device, the draft plan creating device 106 can consult an additional constraint condition to be satisfied when a draft operation plan of the resource A is made. Next, a data structure of the draft plan information 114 according to the embodiment will be explained.

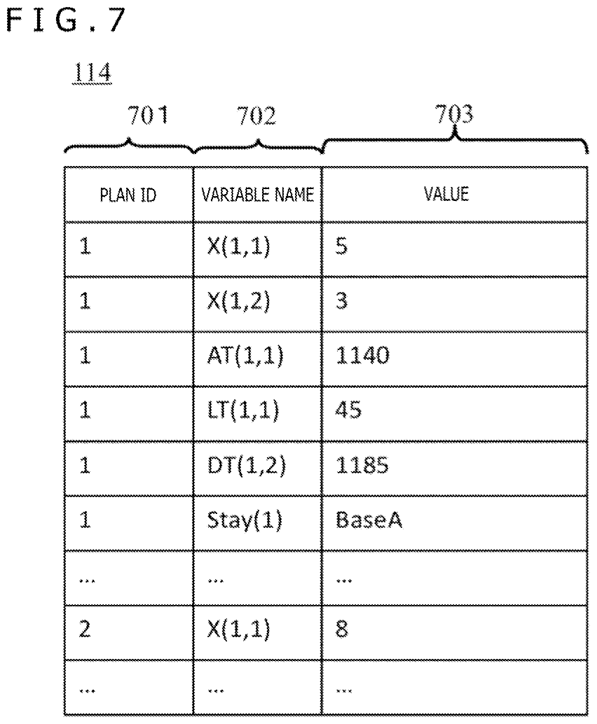

FIG. 7 illustrates a data structure of the draft plan information 114 according to the embodiment. The draft plan information 114 is created by the draft plan creating device 106. A plan ID 701 is a number for uniquely identifying a draft operation plan of the resource group A. A variable name 702 indicates a decision variable to be decided in a draft plan. A value 703 indicates the value of a decision variable in the draft plan. When the values of all decision variables are given, a draft plan having a specific plan ID is described. That is, in a draft plan the “plan ID” of which is “1,” a value of “X(1,1)” is “5,” and a value of “X(1,2)” is “3.” The values are given for all the decision variables in this manner, and the draft plan is thus expressed. Next, a data structure of the estimated cooperation partner's evaluation index information 115 according to the embodiment will be explained.

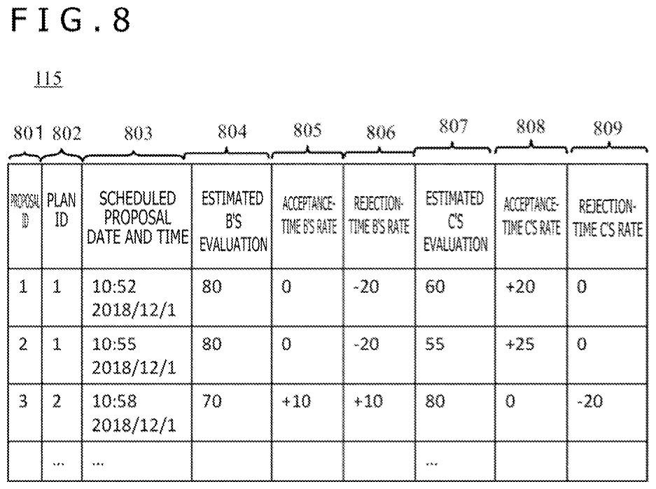

FIG. 8 illustrates a data structure of the estimated cooperation partner's evaluation index information 115 according to the embodiment. The estimated evaluation index information 115 is created by the cooperation partner's evaluation estimating device 107. A proposal ID 801 is a number for uniquely identifying a plan proposing process to other organizations. A plan ID 802 is a number for uniquely identifying a draft operation plan of the resource group A in the present embodiment. A scheduled proposal date and time 803 indicates a date and time when the plan identified by the plan ID is scheduled to be transmitted to the plan cooperation partner reply providing device 101 in a proposing process identified by the proposal ID.

The remaining columns indicate estimated evaluation values 804 and 807 and rate fluctuation values 805, 806, 808, and 809. The estimated evaluation values 804 and 807 are made by the other organizations for a draft plan identified by the plan ID 802, when the draft plan is transmitted to the plan cooperation partner reply providing device 101 at the time indicated by the scheduled proposal date and time 803. The rate fluctuation values 805, 806, 808, and 809 are rate fluctuation values of the other organizations when the draft plan has been accepted or rejected by the other organizations.

The estimated evaluation values 804 and 807 which are provided from the other organizations indicate evaluation values of the draft plan from the standpoints of the other organizations (subjects managing the resources B and C in the present embodiment). It is assumed that algorithms for the evaluations are previously defined through the terminal device 110 before the system is operated. The algorithms for the evaluations may be provided after the algorithms are created by the other organizations.

The algorithms for evaluations may be unchangeable with time or may change with time. In the present embodiment, time-dependent algorithms are adopted. That is, an estimated evaluation value of the same draft plan changes depending on the scheduled proposal date and time 803. The reason for this is that there is a case where each organization needs to consider its own convenience even though they belong to the same organization. It is to be noted that time-dependent algorithms may also be used for evaluation algorithms for the plan self-evaluation device 103.

The rate fluctuation values 805, 806, 808, and 809 are calculated by the cooperation partner's evaluation estimating device 107 on the basis of the estimated evaluation values 804 and 807. In the present embodiment, a policy of making a rate increase larger at an acceptance time while making a rate decrease smaller at a rejection time as an estimated other organization's evaluation is lower, is adopted to calculate the rate fluctuation values. That is, the rate fluctuation values depend on both the estimated other organization evaluations and replies because, in a case where an estimated evaluation value is low but an acceptance is obtained, a reward should be reflected on the rate of an organization that has given the acceptance, for example.

For example, in a case where cooperation partners are the organization managing the resource group B and the organization managing the resource group C, the estimated B's evaluation value 804 of a draft plan identified by the plan ID of “1” and the proposal ID of “1” is “80,” the B's rate fluctuation value 805 when the proposal is accepted by B is “0,” and the B's rate fluctuation value 806 when the proposal is rejected is “−20.” Moreover, the estimated C's evaluation value 807 of the draft plan is “60,” and the rate fluctuation value 808 when the proposal is accepted by C is “+20,” and the rate fluctuation value 809 when the proposal is rejected by C is “0.” Next, a data structure of the cooperation partner's rate information 116 according to the embodiment will be explained.

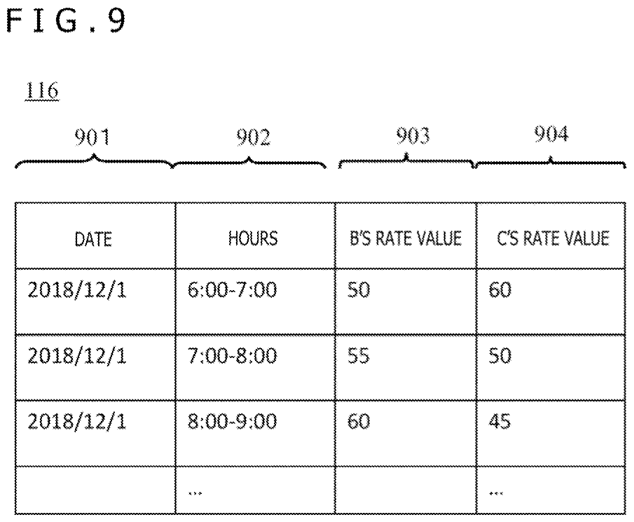

FIG. 9 illustrates a data structure of the cooperation partner's rate information 116 according to the embodiment. Each time an acceptance or a rejection is replied from a cooperation partner, the cooperation partner's rate computing device 108 calculates a rate value of the cooperation partner's rate information 116 by consulting the estimated evaluation index information 115, and the contents of the cooperation partner's rate information 116 are updated. A date 901 and hours 902 indicate the date and hours for uniquely identifying a time period having a fixed width. The remaining columns indicate the rate values of respective cooperation partners at the corresponding date 901 and hours 902. That is, a B's rate value 903 and a C's rate value 904 are “50” and “60,” respectively, during “6:00-7:00” on “2018/12/01.” The data structures have been explains so far. Next, processes will be explained. First, processes in the system will generally be explained.

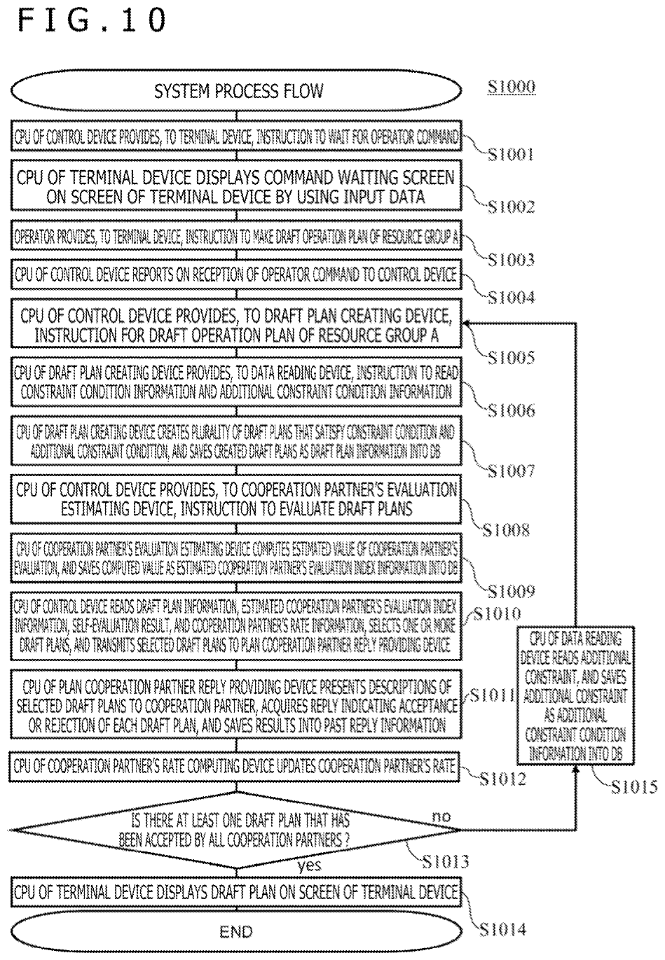

FIG. 10 generally illustrates a system process flow S1000 according to the embodiment.

In step S1001, the CPU 201 of the control device 105 provides, to the terminal device 110, an instruction to wait for an operator command.

In step S1002, the CPU 201 of the terminal device 110 displays a command waiting screen on the screen 206 of the terminal device 109.

In step S1003, an operator of the multi-subject cooperation plan system 100 provides, to the terminal device 110, an instruction to make a draft operation plan of the resource group A.

In step S1004, the CPU 201 of the terminal device 110 reports on reception of the operator command, to the control device 105.

In step S1005, the CPU 201 of the control device 105 provides, to the draft plan creating device 106, an instruction for a draft operation plan of the resource group A.

In step S1006, the CPU 201 of the draft plan creating device 106 provides, to the data reading device 104, an instruction to read the constraint condition information 112 and the additional constraint condition information 113, and then, the data reading device 104 reads the data.

In step S1007, the CPU 201 of the draft plan creating device 106 creates a plurality of draft plans satisfying the constraint condition information 112 and the additional constraint condition information 113, and saves the created draft plans as the draft plan information 114 into the DB device 109. Here, a general-purpose mathematical optimization tool such as a CP solver or a MIP solver can be used to create draft plans satisfying a given constraint condition.

In step S1008, the CPU 201 of the control device 105 provides, to the cooperation partner's evaluation estimating device 107, an instruction to compute estimated cooperation partner evaluation values of the draft plans saved in the draft plan information 114.

In step S1009, the CPU of the cooperation partner's evaluation estimating device 107 computes an estimated value of the cooperation partner's evaluation, and saves the computed value as the estimated cooperation partner's evaluation index information 115 into the DB device 109. Here, an estimated cooperation partner's evaluation value (804 and 807 in FIG. 8) may be designed as a function to an operation plan of the resource group A, for example. For example, in a case where an operation plan of the resource group A is related to operation on a railroad and the cooperation partner B is an organization managing resources related to maintenance, a B's evaluation may be designed as a function including a place for overnight stay of each vehicle, a time of arrival at the place for overnight stay for maintenance, a time of departure for the next day's operation on the rail from the place for overnight stay, and a scheduled plan proposal date and time. In addition, in order to design the function, data regarding evaluation values given for the past draft plans by an operator of B may be collected, a common data mining technology such as curve fitting or machine learning may be performed on the data. The scheduled plan proposal date and time may be calculated by adding a certain time period to a plan drafting time, for example. It is assumed that these functions are saved in the hard disk 208 or the like of the cooperation partner's evaluation estimating device 107 before the system is operated.

Further, in step S1009, the CPU of the cooperation partner's evaluation estimating device 107 computes the rate fluctuation of a cooperation partner organization when a proposed plan is accepted by the cooperation partner organization and the rate fluctuation when the proposed plan is rejected by the cooperation partner organization, on the basis of the estimated evaluation values. The rate fluctuation may be calculated by defining a reference value for an estimated evaluation at an acceptance time and a reference value for an estimated evaluation at a rejection time, and using the difference from the reference value. For example, when an estimated B's evaluation value of the draft plan is defined as EV and the acceptance-time reference value is defined as SV_accept, an acceptance-time rate fluctuation ΔR_accept may be calculated by Expression (1).

[Math. 1]

ΔR_{accept}=max(0,EV−SV_{accept}) (1)

Alternatively, when an estimated B's evaluation value of a draft plan is defined as EV and a rejection-time reference value is defined as SV_reject, a rejection-time rate fluctuation may be calculated by Expression (2), for example.

[Math. 2]

ΔR_{reject}=min(0,SV_{reject}−EV) (2)

Further, any other function may be designed to calculate a rate fluctuation value. In particular, a function in which the rate fluctuation value depends on a proposal time may be designed.

In step S1010, the CPU 201 of the control device 105 reads the draft plan information 114, the estimated cooperation partner's evaluation index information 115, the cooperation partner's rate information 116, and an evaluation result obtained by the plan self-evaluation device 103, selects one or more draft plans, and transmits the selected draft plans to the plan cooperation partner reply providing device 101. Here, draft plans to be transmitted to the plan cooperation partner reply providing device 101 are evaluated and sorted by an objective function of expression (3), for example.

In one example of a draft plan selecting method, one or more draft plans for which large objective functions are obtained are preferentially selected from a plurality of draft plans. The selected draft plans may be displayed on the terminal device 110 to allow an operator of the multi-subject cooperation plan system 100 to make a selection from among the displayed draft plans, and the selected draft plan may be transmitted to the plan cooperation partner reply providing device 101. Alternatively, a draft plan for which the largest objective function is obtained may automatically be transmitted to the plan cooperation partner reply providing device 101.

[Math. 3]

Vₜₒₜₐₗ=V_{A}+R_{B}*EV_{B}+R_{C}*EV_{C} (3)

V_A represents a KPI (Key Performance Indicator) evaluation of a draft plan made by the organization A, EV_B and EV_C respectively represent an estimated organization B's evaluation value and an estimated organization C's evaluation value of the draft plan, R_B and R_C respectively represent the current rate value of the organization B and the current rate value of organization C. V_A is calculated by the plan self-evaluation device 103 with a first algorithm. EV_B and EV_C are calculated by the cooperation partner's evaluation estimating device 107 with the second and third algorithms, respectively. R_B and R_C are calculated by the cooperation partner's rate computing device 108. It is to be noted that, in place of R_B and R_C in Expression (3), any function including R_B and R_C may be used as weights.

In step S1011, the CPU 201 of the plan cooperation partner reply providing device 101 presents descriptions of the selected draft plans to the cooperation partner, acquires a reply indicating an acceptance or a rejection of each of the draft plans, saves the results in the past reply information 111, and reports on acquisition of the reply to the control device 105.

In step S1012, the cooperation partner's rate computing device 108 computes a cooperation partner's rate. For example, the sum of the reply rate fluctuations concerning an acceptance/rejection of each draft plan may be obtained, and may be added to the original cooperation partner's rate. Alternatively, the cooperation partner's rate computing device 108 may consult the past reply information 111 illustrated in FIG. 3, and update the rates for every entry according to the contents of the reply 307. Alternatively, a predetermined number of entries may be collected, and batch processing may be performed. The updated rate values are recorded as the cooperation partner's rate information 116.

For example, an appropriate weight function that is set for each cooperation partner may be applied to the sum. For example, a function of a cooperation partner's rate in an operation time period of a day may previously be determined on the basis of the flexibility or importance of resource operation by the cooperation partner, and the function may be parallel-moved, enlarged, or reduced on the basis of the sum, whereby the cooperation partner's rate can be computed.

In step S1013, the control device 105 reads the past reply information 111, and determines whether any one of the draft plans has been accepted by all the cooperation partners. When the determination is affirmative, the process proceeds to step S1014. When the determination is negative, the process proceeds to step S1015.

In step S1014, the CPU 201 of the terminal device 110 displays the draft plans and the cooperation partner's rate information on the screen of the terminal device 110.

In step S1015, the CPU 201 of the data reading device 104 reads an additional constraint from the past reply information 111, and saves the read additional constraint as the additional constraint condition information 113 into a DB. After step S1015, the process returns to step S1005 that is based on the updated additional constraint information.

It is to be noted that, in a case where, in step S1013, there is no draft plan accepted by all the cooperation partners after the elapse of a predetermined time period or a predetermined step, the CPU 201 of the terminal device 110 may display, in step S1014, on the screen of the terminal device 110, that acceptances have not been received from all the contact information. Thereafter, the process may be finished.

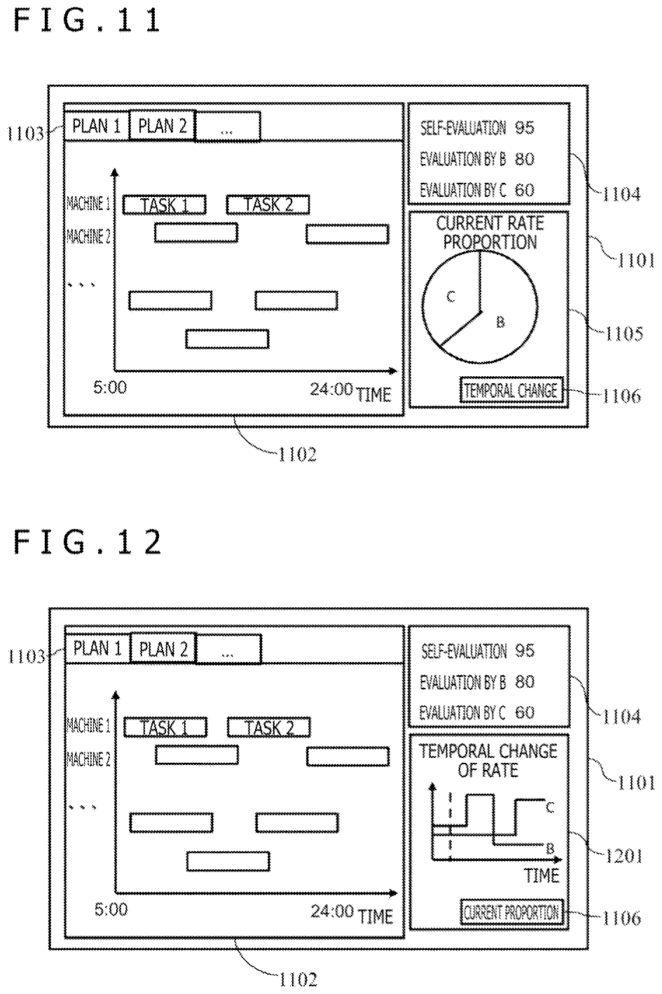

The process flow according to the embodiment has been generally explained. Next, a result display screen regarding the result displaying in step S1104 will be explained with reference to FIGS. 11 and 12.

FIG. 11 is a schematic view of the result display screen according to the embodiment. In FIG. 11, a reference character 1101 denotes a result display screen, a reference character 1102 denotes an operation plan display part, a reference character 1103 denotes a draft plan switching tub, a reference character 1104 denotes a KPI display part, a reference character 1105 denotes a rate ratio display part, and a reference character 1106 denotes a rate display switch button. The result display screen 1101 is displayed on the screen 206 of the terminal device 110.

The operation plan display part 1102 displays an operation plan of the resource group A accepted by all the cooperation partners. In a case where there are a plurality of draft plans accepted by all the cooperation partners, the draft plan switching tub 1103 is pressed to display another draft plan. The KPI display part 1104 displays relevant KPIs which are an organization's KPI of the draft plan displayed in the operation plan display part 1102 and estimated cooperation partner's evaluations of the draft plan. The rate ratio display part 1103 displays the current ratio of the cooperation partner's rates. When the rate display switch button 1106 is pressed, the temporal change of a cooperation partner's rate may be displayed in place of the current ratio. FIG. 12 illustrates a display screen on which switching to the temporal change of the rate has been performed.

FIG. 12 is a diagram illustrating that the display form of the cooperation partner's rate information has been changed on the result display screen in the embodiment. In FIG. 12, a reference character 1201 denotes a temporal rate change display part. The temporal change of a cooperation partner's rate is displayed on the temporal rate change display part in which a rate and a time are indicated on the vertical axis and the horizontal axis, respectively. When the rate display switch button 1106 is pressed, the display returns to the current ratio of the cooperation partner's rates.

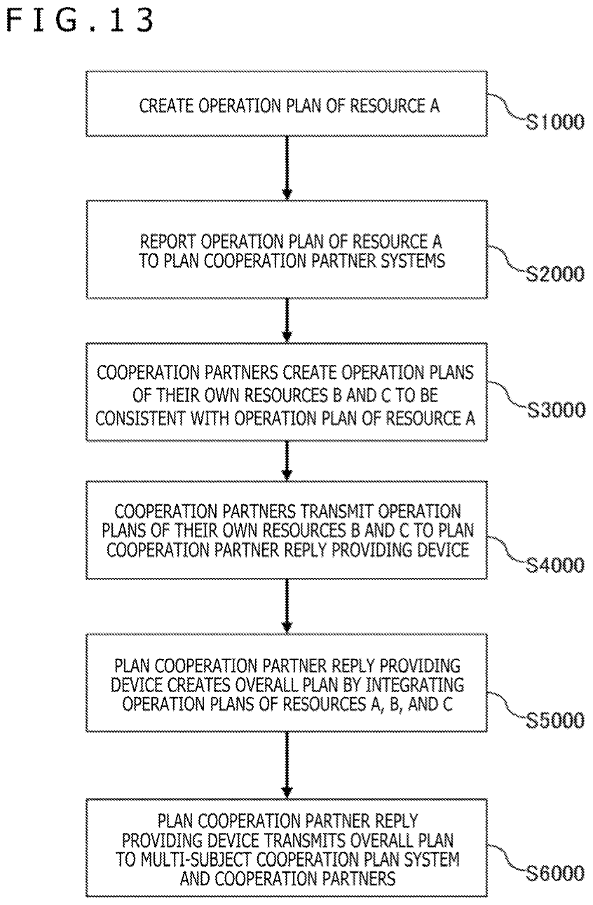

FIG. 13 is a flowchart for explaining the flow of creating an overall plan according to the embodiment.

In process S1000, the multi-subject cooperation plan system 100 creates an operation plan of the resource A. This process has been explained with reference to FIG. 10. As a result of process S1000, one or more draft plans accepted by all cooperation partners are created (process S1013). The result is displayed to an operator of the multi-subject cooperation plan system 100 (process S1014), as illustrated in FIG. 11 or FIG. 12. In a case where there are two or more operation plans accepted by all the cooperation partners, one of the operation plans is selected with use of the terminal device 110 so as to be proposed to the cooperation partners.

In process S2000, the control device 105 of the multi-subject cooperation plan system 100 reports the description of the selected operation plan of the resource A to the plan cooperation partner systems 117-1 and 117-2 via the network 102-1, the plan cooperation partner reply providing device 101, and the network 102-2.

In process S3000, the cooperation partners create respective operation plans of their own resources B and C in such a way that the operation plans do not conflict with the operation plan of the resource A received by the plan cooperation partner systems 117-1 and 117-2. The operation plans may manually be created by the cooperation partners. Alternatively, the plan cooperation partner systems 117-1 and 117-2 may include a device that is equivalent to the draft plan creating device 106 so as to automatically create the operation plans.

In process S4000, the cooperation partners transmit the operation plans B and C of their own resources to the plan cooperation partner reply providing device 101 by using the plan cooperation partner systems 117-1 and 117-2.

In process S5000, the plan cooperation partner reply providing device 101 creates an overall plan by integrating the operation plans of the resources A, B, and C. The details of the operation plans of the respective resources and integration of the operation plans are publicly known, and thus, a detailed explanation thereof will be omitted.

In process S5000, the plan cooperation partner reply providing device 101 transmits the overall plan to the multi-subject cooperation plan system 100 and the plan cooperation partner systems 117-1 and 117-2.

In the above explanation, process S5000 of creating an overall plan and process S6000 of reporting the overall plan are performed by the plan cooperation partner reply providing device 101. However, the plan cooperation partner reply providing device 101 may be omitted, and process S5000 and process S6000 may be performed by the multi-subject cooperation plan system 100.

In the manner explained so far, the multi-subject cooperation plan system 100 creates an operation plan of the resource A accepted by the cooperation partners. The plan is transmitted to the cooperation partners, and the cooperation partners create respective operation plans of the resources B and C so as not to conflict with the transmitted plan. An overall plan is completed by integrating the operation plans of the respective resources. In the present embodiment, an overall plan can efficiently be created, compared to a conventional method in which operation plans of resources are drafted and coordination between the plans is then executed to create an overall plan.

According to the embodiment explained so far, an objective function for evaluating a plan created by the draft plan creating device 106 of the multi-subject cooperation plan system 100 includes not only a self-evaluation element but also a cooperation partner's evaluation element. For this reason, a plan that is easily acceptable to the cooperation partner can be proposed. In addition, since the cooperation partner's evaluation element is weighted, the details of the plan created by the draft plan creating device 106 can easily be coordinated even if there are a plurality of cooperation partners.

Further, the multi-subject cooperation plan system 100 collects replies from the cooperation partners, and calculates, at the cooperation partner's rate computing device 108, the weights of the respective cooperation partners on the basis of the replies. Since the weights are adjusted on the basis of the past cooperation partner replies, the behavioral characteristics of the cooperation partners can be reflected on the objective function. For example, the weight of a cooperation partner is adjusted on the basis of the contents of a reply which indicates an acceptance or a rejection of a plan. Accordingly, the weight of a cooperation partner that is cooperative becomes large, so that it can be expected that the cooperation partner will favorably be treated during future planning. For this reason, each planning subject voluntarily makes a plan that is more acceptable while considering the conveniences of other subjects. If a conflict occurs between the plans, a subject that can make a concession is motivated to voluntarily make the concession. Consequently, coordination between the plans can be executed smoothly and swiftly.

It is to be noted that provision of a railroad traffic service has been explained in the embodiment. However, the present embodiment is similarly applicable to the other transportation fields of airplanes, ships, passengers, etc. The present embodiment is also applicable to the manufacturing field and the logistics field when coordination among a plurality of operation plans of resources is executed. Further, the three resources A, B, and C are given in the embodiment, but, needless to say, the present embodiment is similarly applicable to a case where there are two resources and a case where there are four or more resources.

The embodiment has been explained above, but the present invention is not limited to the present embodiment and encompasses a variety of modifications. For example, all the explained constituent elements are not necessarily provided because the above embodiment has been given for explaining the present embodiment in an easily understand manner. Moreover, some of constituent elements of a certain embodiment can be replaced with constituent elements of another embodiment. A constituent element of a certain embodiment can be added to a constituent element of another embodiment. Any other constituent element can be added to some of constituent elements of each embodiment. Some constituent elements can be eliminated or can be replaced with other constituent elements.

Some or all of the abovementioned constituent elements, functions, processing units, processing means, etc., may be implemented by hardware by being designed on an integrated circuit, for example. Alternatively, when a processor interprets and executes programs for implementing the respective functions, the abovementioned constituent elements and functions, etc., may be implemented by software. Information of programs, tables, files, etc., for implementing the functions may be stored in a recording device such as a memory, a hard disk, or an SSD (Solid State Drive), or in a recording medium such as an IC card, an SD card, or a DVD.

In addition, control lines and information lines that are necessary for the explanations are described, but all the control lines and information lines in a product are not described. It can be considered that almost all the sections are connected to one another in practice.

In addition, cooperation of rail operation plans, maintenance plans, and manpower resource operation plans has been explained in the embodiment. However, application of the present invention is not limited to the railway business, and is applicable to allocation of resources in the transportation services such as airplane operation and MaaS (Mobility as a Service), the manufacturing business, and any other services.

### DESCRIPTION OF REFERENCE CHARACTERS

100: Multi-subject cooperation plan system
101: Plan cooperation partner reply providing device
102: Network
103: Multi-subject cooperation plan system
104: Data reading device
105: Control device
106: Draft plan creating device
107: Cooperation partner's evaluation estimating device
108: Cooperation partner's rate computing device
109: DB device
110: Terminal device
111: Past reply information
112: Constraint condition information
113: Additional constraint condition information
114: Draft plan information
115: Estimated cooperation partner's evaluation index information
116: Cooperation partner's rate information
1101: Result display screen
1102: Operation plan display part
1103: Draft plan switching tub
1104: KPI display part
1105: Rate ratio display part
1106: Rate display switch button
1201: Result display screen

1. A multi-subject cooperation plan system comprising:
a draft plan creating device that creates a plurality of draft plans satisfying a given constraint condition;
an evaluation device that evaluates each of the draft plans with a first algorithm and generates a self-evaluation value;
an evaluation estimating device that evaluates each of the draft plans with a second algorithm different from the first algorithm and generates an estimated cooperation partner's evaluation value; and
a cooperation partner's rate computing device that computes a rate indicating a weight of the estimated cooperation partner's evaluation value, wherein
the plurality of draft plans are evaluated on a basis of an objective function that is calculated from the self-evaluation value, the estimated cooperation partner's evaluation value, and the rate.

2. The multi-subject cooperation plan system according to claim 1, comprising:
a control device that transmits, to a cooperation partner, a draft plan selected from among the plurality of draft plans and receives, from the cooperation partner, a reply to the transmission; and
a data reading device that records, as past reply information, the reply received from the cooperation partner, wherein
the cooperation partner's rate computing device computes the rate on a basis of the past reply information.

3. The multi-subject cooperation plan system according to claim 2, wherein
the past reply information includes a reply indicating an “acceptance” or a “rejection” of the draft plan from the cooperation partner, and
the cooperation partner's rate computing device increases or decreases the rate according to the reply indicating the “acceptance” or the “rejection.”

4. The multi-subject cooperation plan system according to claim 3, wherein
the evaluation estimating device calculates, on a basis of the estimated cooperation partner's evaluation value, a rate fluctuation value corresponding to the reply indicating the “acceptance” and a rate fluctuation value corresponding to the reply indicating the “rejection,” and
the cooperation partner's rate computing device increases or decreases the rate on a basis of the reply indicating the “acceptance” or the “rejection” and the rate fluctuation value.

5. The multi-subject cooperation plan system according to claim 2, wherein
the past reply information includes an additional constraint condition that is set by the cooperation partner with respect to the draft plan, and
the draft plan creating device adds the additional constraint condition to the given constraint condition.

6. The multi-subject cooperation plan system according to claim 1, wherein
at least one of the first algorithm and the second algorithm is a time-dependent algorithm.

7. The multi-subject cooperation plan system according to claim 2, wherein
the control device transmits, in a case where replies received from the cooperation partners in response to the transmission all indicate “acceptance” of the draft plan, the accepted draft plan to the cooperation partners.

8. The multi-subject cooperation plan system according to claim 7, comprising:
a terminal device that displays, in the case where the replies received from the cooperation partners in response to the transmission all indicate the “acceptance” of the draft plan, information indicating the draft plan, the self-evaluation value, the estimated cooperation partner's evaluation value, and the rate.

9. A multi-subject cooperation plan method that is executed by an information processing apparatus including a central processing unit and a storage device, the method comprising:
a first step of reading a constraint condition from the storage device;
a second step of creating, by the central processing unit, a plurality of draft plans satisfying the constraint condition;
a third step of evaluating, by the central processing unit, each of the plurality of draft plans with a first algorithm and generating a self-evaluation value;
a fourth step of evaluating, by the central processing unit, each of the plurality of draft plans with a second algorithm different from the first algorithm and generating an estimated cooperation partner's evaluation value;
a fifth step of reading, from the storage device, cooperation partner's rate information that indicates a weight of the estimated cooperation partner's evaluation value;
a sixth step of calculating, by the central processing unit, an objective function for each of the plurality of draft plans from the self-evaluation value, the estimated cooperation partner's evaluation value, and the cooperation partner's rate information;
a seventh step of presenting, by the central processing unit, at least one draft plan selected from among the draft plans to a cooperation partner and receiving a reply to the selected draft plan;
an eighth step of recording, by the central processing unit, contents of the reply as past reply information into the storage device; and
a ninth step of updating, by the central processing unit, the cooperation partner's rate information on a basis of the past reply information.

10. The multi-subject cooperation plan method according to claim 9, wherein,
after a tenth step of recording, by the central processing unit, an additional constraint condition included in the reply into the storage device is executed,
the method is returned to the first step, and
the additional constraint condition is added to the constraint condition in the first step.
